(19) United States
(12) Patent Application Publication
(10) Pub. No.: US 2026/0346200 A1
(43) Pub. Date: Nov. 5, 2026

(54) METHOD FOR CONTROLLING SEMICONDUCTOR PROCESS ENVIRONMENT

(71) Applicant: TAIWAN SEMICONDUCTOR MANUFACTURING COMPANY LTD., HSINCHU (TW)

(72) Inventors: HAO-MING CHANG, PINGTUNG CITY (TW); CHUN-LANG CHEN, TAINAN CITY (TW)

(21) Appl. No.: 19/738,598

(22) Filed: Jul. 13, 2026

Related U.S. Application Data
(62) Division of application No. 18/925,092, filed on Oct. 24, 2024.

(51) Int. Cl. B01D 53/88; B01D 53/00; B01D 53/02; B01D 53/26; B01D 53/28; B01D 53/86

(52) U.S. Cl. CPC B01D 53/885; B01D 53/007; B01D 53/02; B01D 53/261; B01D 53/28; B01D 53/8662; B01D 53/8687; B01D 53/869; B01D 2253/102; B01D 2253/106; B01D 2253/112; B01D 2253/1124; B01D 2253/202; B01D 2255/102; B01D 2255/1021; B01D 2255/1023; B01D 2255/1025; B01D 2255/1026; B01D 2255/1028; B01D 2255/104; B01D 2255/106; B01D 2255/2065; B01D 2255/20707; B01D 2255/20753; B01D 2255/802; B01D 2255/9025; B01D 2255/904; B01D 2257/2064; B01D 2257/70; B01D 2257/80; B01D 2259/802; B01D 2259/804

(57) ABSTRACT

A method for controlling the semiconductor process environment is provided. The method includes placing a cleaning member in a processing chamber of a semiconductor processing tool. The method also includes creating a vacuum in the processing chamber. Furthermore, the method includes eliminating at least one compound from the residues in the processing chamber by the cleaning member. The cleaning member is configured to facilitate physical adsorption, catalysis, or chemical reactions with the residues in the processing chamber.

### PRIORITY CLAIM AND CROSS-REFERENCE

This application is a divisional application of U.S. application Ser. No. 18/925,092 filed on Oct. 24, 2024. The contents of the above-referenced Patent Application are hereby incorporated by reference in their entirety.

### BACKGROUND

As semiconductor manufacturing technology advances towards more sophisticated nodes, the semiconductor industry continues to improve precision of processes such as etching, deposition, and metrology. As a result, some semiconductor tools are developed to operate within high-vacuum environments. Under the high-vacuum conditions the manufacturing processes can be precisely controlling and contamination from hydrocarbons, water molecules, and toxic by-products, which can degrade the quality and functionality of the semiconductor devices, can be prevented.

Currently, the turbo pumps used to create a high-vacuum conditions. While this level of vacuum is generally sufficient for many applications, it may not be adequate to fully prevent the growth of contaminants such as hydrocarbons, water molecules, and by-products on the surfaces involved in the manufacturing process. The presence of these contaminants may adversely affect manufacturing processes where the feature size below 10 Å. At such small scales, even minimal contamination would significantly affect surface characteristics, leading to defects in the final product and impairing the performance of the semiconductor devices.

Consequently, it would be desirable to provide a solution for maintaining ultra-clean environments within semiconductor tools.

### BRIEF DESCRIPTION OF THE DRAWINGS

Aspects of the embodiments of the present disclosure are best understood from the following detailed description when read with the accompanying figures. It is noted that, in accordance with the standard practice in the industry, various structures are not drawn to scale. In fact, the dimensions of the various structures may be arbitrarily increased or reduced for clarity of discussion.

FIG. 1 is a schematic view diagram illustrating a semiconductor processing tool, in accordance with some embodiments of the present disclosure.

FIG. 2 is a schematic view diagram illustrating a cleaning member, in accordance with some embodiments of the present disclosure.

FIG. 3 is a schematic view diagram illustrating a cleaning member, in accordance with some embodiments of the present disclosure.

FIGS. 4A-4F are schematic view diagrams illustrating cleaning members having various geometric shape, in accordance with some embodiments of the present disclosure.

FIG. 5 is a flow chart illustrating a method for controlling the semiconductor process environment, in accordance with various aspects of one or more embodiments of the present disclosure.

FIG. 6 is a schematic view diagram illustrating a device for measuring an electrical property of a cleaning member, in accordance with various aspects of one or more embodiments of the present disclosure.

FIG. 7 is a schematic view diagram illustrating a device for measuring optical properties of a cleaning member, in accordance with various aspects of one or more embodiments of the present disclosure.

FIG. 8 is a schematic view diagram illustrating a device for measuring at least one property of the residues, in accordance with various aspects of one or more embodiments of the present disclosure.

### DETAILED DESCRIPTION

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the terms such as “first,” “second” and “third” describe various elements, components, regions, layers and/or sections, these elements, components, regions, layers and/or sections should not be limited by these terms. These terms may be only used to distinguish one element, component, region, layer or section from another. The terms such as “first,” “second” and “third” when used herein do not imply a sequence or order unless clearly indicated by the context.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation.

When used herein the term “residue” means encompasses a broad range of materials and substances that may be present within a semiconductor processing chamber. For example, “residue” is defined to include, but is not limited to, the following elements: (1) by-products: any gaseous or solid by-products generated as a result of chemical reactions or physical processes during semiconductor manufacturing, such as etching, deposition, or other processes conducted within the chamber; (2) residual gases: gases that remain in the chamber following maintenance activities, including gases left after the chamber has been disassembled and reassembled, or after any fixing or servicing procedures. These residual gases may include ambient air, cleaning agents, or process gases that were not fully evacuated from the chamber; and (3) operational elements: elements or compounds that are created as a result of the normal operation of devices or tools within the chamber. These may include wear particles from moving components, reaction by-products from tool operations, or any other substances generated during the use of the chamber's equipment.

One objective of the present disclosure is to provide a new method that enables passive self-cleaning within all semiconductor tools equipped with vacuum systems. This method is designed to provide an ultra-clean environment for manufacturing tools, thereby reducing the risk of contamination and improving the reliability and performance of the semiconductor devices produced. The approach is not only effective but also cost-efficient, making it an attractive solution for maintaining the cleanliness of semiconductor processing environments with less cost.

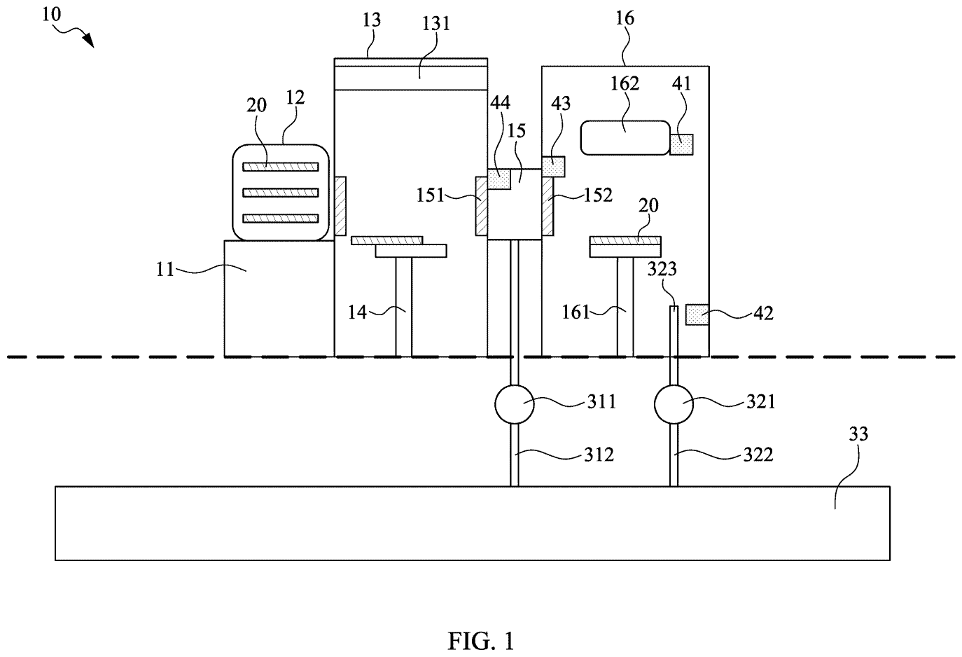

FIG. 1 shows a schematic view diagram illustrating a semiconductor processing tool 10, in accordance with some embodiments of the present disclosure. In some embodiments, the semiconductor processing tool 10 includes a load port 11, an interface 13, a load lock device 15, and a processing chamber 16.

The load port 11 is configured to facilitate the transfer of wafer carriers 12 into the semiconductor processing tool 10. The load port 11 supports and docks the wafer carrier 12, which may be standard mechanical interfaces (SMIFs) for loading 200 mm semiconductor wafers, or front opening unified pods (FOUPs) for 300 mm, 450 mm, or larger diameter wafers. The load port 11 may incorporate a purge system to maintain a clean environment within the wafer carrier, preventing the ingress of airborne particles and moisture.

The interface 13 is positioned between the load port 11 and the load lock device 15. A transferring member, such as a robot arm 14, is located within the interface 13 to transport the wafers from the wafer carrier 12 to the load lock device 15. The interface 13 is equipped with a high-efficiency particulate air (HEPA) filter 131 to make the air supplied into the interface from the clean room free of contaminants. The HEPA filter 131 is positioned on the top of the interface 13 and removes airborne particles, maintaining a clean environment for wafer handling.

The load lock device 15 enables the transition of semiconductor wafers from ambient air pressure conditions in the interface 13 to the vacuum environment of the processing chamber 16. The load lock device 15 is a vacuum chamber equipped with a first door 151 connected to the interface 13 and a second door 152 connected to the processing chamber 16. During the wafer transfer process, the first door 151 of the load lock device 15 opens to receive the wafer from the interface 13. Once the wafer is positioned inside the load lock device 15, the first door 151 closes, and the chamber is pumped down to a vacuum level that matches the pressure in the processing chamber 16. This pump-down process is achieved using a first pump 311, which evacuates the gas from the load lock device 15 through the conduit 312 and exhausts it to a waste passage 33.

Once the desired vacuum level is reached in the load lock device 15, the second door 152 opens, allowing the semiconductor wafer 20 to be transferred into the processing chamber 16. The processing chamber 16 is where the processing of the semiconductor wafer 20 takes place. The processing chamber 16 is equipped with a wafer chuck 161, which holds the wafer in place during processing, allowing alignment and uniform treatment across the wafer surface.

The processing chamber 16 is also equipped with a radiation source 162, which generates the energy required for processing the semiconductor wafer 20. The type of radiation source 162 varies depending on the specific application of the semiconductor processing tool 10. For example, in case where the semiconductor processing tool 10 is an extreme ultraviolet (EUV) lithography tool, the radiation source 162 may be a light source that produces EUV light to expose the photoresist material applied on the wafer. EUV lithography utilizes light with a wavelength of around 13.5 nm, which is much shorter than the wavelengths used in traditional optical lithography. This allows for the creation of smaller features on the wafer, enabling the production of more advanced and densely packed semiconductor devices. The EUV light source typically consists of a laser-driven plasma source or a discharge-produced plasma source, which generates high-intensity EUV light by heating a target material to extremely high temperatures. The generated EUV light is then collected, filtered, and focused onto the semiconductor wafer 20 using a complex system of mirrors and optics.

To maintain the vacuum condition, the processing chamber 16 is equipped with a second pump 321. The second pump 321 evacuates the gas from the processing chamber 16 through the conduit 322 and exhausts it to the waste passage 33. The second pump 321 achieves the required molecular partial pressures, typically ranging between 5×10⁻⁷ to 5×10⁻⁸ Pa, providing an environment for semiconductor processing.

In the case where the semiconductor processing tool 10 is an etching tool, the radiation source 162 may be an electrode that generates plasma within the processing chamber 16 to perform the etching process. The electrode, typically made of a conductive material such as copper or aluminum, is connected to a power supply that applies a high-frequency voltage. This voltage ionizes the gas molecules in the processing chamber 16, creating a plasma consisting of ions, electrons, and neutral species. The ions in the plasma are accelerated towards the wafer surface by an electric field, where they collide with the material to be etched. This collision results in a chemical reaction that removes the material from the wafer surface, creating the desired patterns and structures. The type of gas used in the plasma etching process depends on the material being etched and the desired etching characteristics. For example, chlorine-based gases are commonly used for etching silicon, while fluorine-based gases are used for etching silicon dioxide and other dielectric materials.

Still referring to FIG. 1, in accordance with some embodiments, the semiconductor processing tool 10 further includes a number of cleaning members, such as cleaning members 41, 42, 43, and 44, enabling passive self-cleaning within the semiconductor processing tool 10. In some embodiments, the cleaning members 41, 42, 43, and 44 are positioned at locations within the semiconductor processing tool 10 where residue is likely to be generated, and characteristics of the cleaning members 41, 42, 43, and 44 vary depending on the type of residue generated in the location it is positioned.

For example, due to the high temperature at the radiation source 162, particles or excited substances within the chamber 16 are likely to be generated during operation. Therefore, the cleaning member 41 is positioned near the radiation source 162 to capture or neutralize particles and excited substances generated by the radiation source 162. This may help to minimize contamination within the chamber 16 and keep the radiation source operates at optimal performance. Alternatively, the cleaning member 42 can be positioned near the inlet 323 of the conduit 322 for removing the gaseous elements from the chamber 16, to preliminarily process toxic or explosive gases (such as hydrogen) before they leave the chamber 16. This helps to maintain a safe working environment and prevents potential hazards. Additionally, the cleaning members 43 and 44 may be respectively positioned next to the first door 151 and the second door 152, to remove residual substances from the ambient environment (such as moisture and oxygen) that cannot be fully evacuated by the first pump 31 in the load lockdevice 15, preventing them from entering the chamber 16. These substances, such as moisture and oxygen, can be detrimental to the semiconductor manufacturing process. By effectively removing these residual substances, the purity and integrity of the processing environment can be maintained.

It would be understood that the number and positioning of the cleaning members 41, 42, 43, and 44 are not limited to the embodiments shown in FIG. 1 and can be increased or decreased and placed at different locations as demands. Moreover, the cleaning members 41, 42, 43, and 44 can have the same or different compositions, depending on the target residues to be removed. In one embodiment, the compositions of the cleaning members 41, 42, 43, and 44 are all different, allowing them to manage the removal of different residues within the semiconductor processing tool 10. Furthermore, two or more of the cleaning members 41, 42, 43, and 44 with different functions can be placed at the same location. The cleaning members 41, 42, 43, and 44 may also be placed on movable components, such as robot arm, within the chamber to remove residues at different locations within the cavity.

The various embodiments of the cleaning members 41 will be described in detail below.

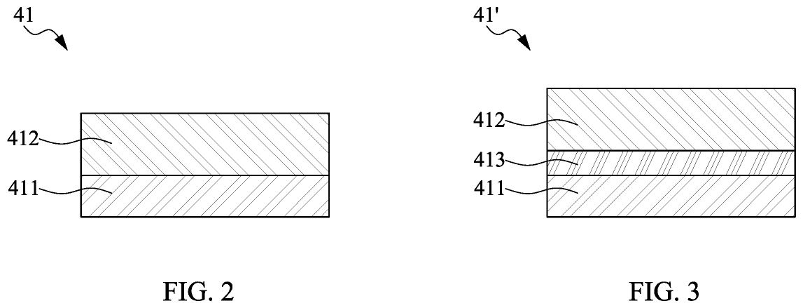

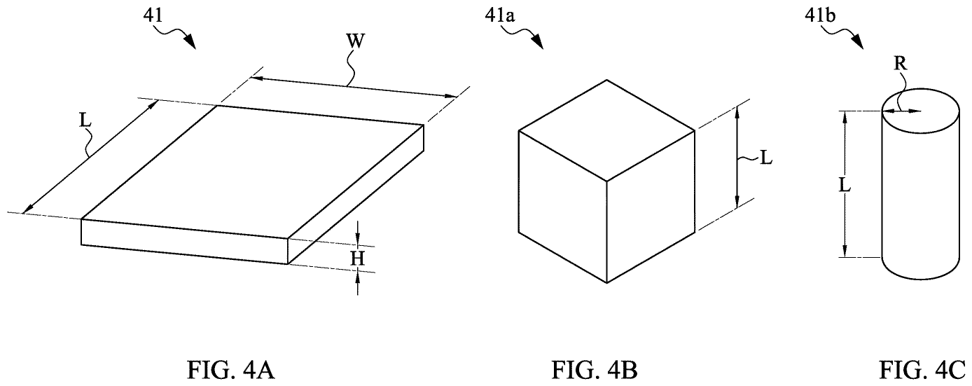

With reference to FIG. 2, in some embodiments, the cleaning members 41 includes a base layer 411 and an exposure layer 412 formed on the base layer 411 through suitable process, such as coating or deposition. Alternatively, as shown in FIG. 3, the cleaning members 41′ includes a middle layer 413 interposed between the base layer 411 and the exposure layer 412.

In accordance with some embodiments, the cleaning member 41 or the cleaning member 41′ is used to absorb attract hydrophobic compounds from the residues in the semiconductor processing tool 10 by a cleaning member having ultra-hydrophobic surface. Example A1 to Example A4 are provided below.

Example A1: The cleaning member 41′, as depicted by FIG. 3, having a three-layer structure is provided. The cleaning member 41′ includes a base layer 411 of silicon dioxide (SiO₂), a middle layer 413 of ruthenium dioxide (RuO₂), and an exposure layer 412 of carbon.

The base layer 411 serves as the foundational support for the cleaning member. The base layer 411 of SiO₂ exhibits stability under the high-temperature and reactive conditions in semiconductor processing environments. The middle layer 413 of RuO₂ functions as a catalyst, enhancing the interaction between the exposure layer 412 and the hydrophobic compounds in the residues. The catalytic properties of ruthenium dioxide facilitate oxidation-reduction reactions and, therefore, can aid in modifying or breaking down complex organic molecules in the residues, making them more susceptible to physical adsorption by the carbon exposure layer. The exposure layer 412 of carbon is used to attract and physically adsorb hydrophobic compounds from the gaseous residues. Carbon materials, such as activated carbon, possess a high surface area and exhibit a strong affinity for non-polar molecules. The hydrophobic nature of the carbon surface allows it to selectively adsorb non-polar compounds, effectively capturing hydrophobic residues and reducing their concentration in the semiconductor processing environment.

In operation, the cleaning member 41 attracts hydrophobic compounds to come into contact with the exposure layer 412 of carbon through van der Waals forces. The middle layer 413 of RuO₂ catalyzes reactions that may alter the chemical structure of these compounds, facilitating their adsorption by the carbon layer. The carbon layer, through its strong affinity for non-polar molecules, traps hydrophobic compounds on its surface.

In other alternative embodiments, the middle layer 413 is formed of a noble metal, such as platinum (Pt), palladium (Pd), or gold (Au), which acts as a catalyst. The noble metal may act as the RuO₂ to enhance the interaction between the carbon exposure layer 412 and the hydrophobic compounds, potentially assisting in breaking down complex organic molecules in the residues, thereby aiding their adsorption by the carbon layer. As a result, the potential for contamination is reduced and the overall cleanliness of the semiconductor processing environment is improved.

Example A2: The cleaning member 41′, as depicted by FIG. 3, having a three-layer structure is provided. The cleaning member 41′ includes a base layer 411 of silicon dioxide (SiO₂), a middle layer 413 of ruthenium dioxide (RuO₂), and an exposure layer 412 of fluoride material.

In this embodiment, the exposure layer 412 is composed of a fluoride material, such as magnesium fluoride (MgF₂) or calcium fluoride (CaF₂). The hydrophobic properties of these fluoride materials make them effective at attracting and adsorbing non-polar compounds. As a result, the exposure layer 412 interacts with the gaseous residues, capturing hydrophobic compounds through non-polar interactions. In operation, the middle layer 413 of RuO₂ catalyzes reactions that assist in breaking down or modifying hydrophobic organic compounds from the residue. The fluoride exposure layer 412 then attracts and adsorbs these hydrophobic compounds, thereby reducing the potential for contamination and improving the overall cleanliness of the semiconductor processing environment.

Example A3: The cleaning member 41, as depicted by FIG. 2, having a two-layer structure is provided. The cleaning member 41 includes a base layer 411 of silicon dioxide (SiO₂) and an exposure layer 412 of fluoride material.

In the absence of a middle layer, the exposure layer 412 of fluoride material directly interacts with the hydrophobic compounds in the residues. The hydrophobic nature of the fluoride material allows it to attract and adsorb non-polar molecules, reducing the concentration of these compounds within the semiconductor processing tool. Compared with the cleaning member in Example A2, this configuration reduces cost and simplifies the manufacturing process.

Example A4: The cleaning member 41, as depicted by FIG. 2, having a two-layer structure is provided. The cleaning member 41 includes a base layer 411 of silicon dioxide (SiO₂) and an exposure layer 412 of polymer.

In this embodiment, the exposure layer 412 is composed of a hydrophobic polymer, such as PMMA. Polymers like PMMA are characterized by their non-polar nature, which makes them effective at attracting and adsorbing hydrophobic compounds. In operation, the polymer exposure layer 412 directly interacts with and adsorbs non-polar, hydrophobic compounds present in the gaseous residues, thereby reducing the potential for contamination and improving the overall cleanliness of the semiconductor processing environment.

In accordance with some embodiments, the cleaning members 41 are used to absorb attract hydrophilic compounds from the residues in the semiconductor processing tool 10 by a cleaning member having ultra-hydrophilic surface. Example B1 to Example B4 are provided below.

Example B1: The cleaning member 41, as depicted by FIG. 2, having a two-layer structure is provided. The cleaning member 41 includes a base layer 411 of silicon dioxide (SiO₂) and an exposure layer 412 of titanium dioxide (TiO₂).

The exposure layer 412 of TiO₂ has strong hydrophilic properties and photolytic capabilities. TiO₂ can form hydroxyl groups on its surface when exposed to water vapor, which increases its affinity for water and other polar molecules. This hydrophilicity is further enhanced when the TiO₂ is exposed to ultraviolet (UV) or visible light (hv light). Under illumination, TiO₂ undergoes photolysis, generating reactive oxygen species and additional surface hydroxyl groups, which further amplify its ability to attract and adsorb hydrophilic compounds from gaseous residues.

In operation, the TiO₂ exposure layer interacts with water molecules and other polar compounds present in the residues. The surface hydroxyl groups on TiO₂ create strong hydrogen bonds with these hydrophilic compounds, effectively capturing them on the exposure layer. When the TiO₂ layer is illuminated with hv light, its photolytic activity is activated. This light exposure enhances the generation of surface hydroxyl groups and reactive oxygen species, which increases the material's capacity to attract and adsorb hydrophilic compounds. As a result, the concentration of water and other polar contaminants within the chamber 16 is reduced, thereby reducing the potential for contamination and improving the overall cleanliness of the semiconductor processing environment.

Example B2: The cleaning member 41, as depicted by FIG. 2, having a two-layer structure is provided. The cleaning member 41 includes a base layer 411 of titanium dioxide (TiO₂) and an exposure layer 412 of titanium dioxide (TiO₂).

In this embodiment, the base layer 411 and the exposure layer 412 are formed integrally, the entire surface of the cleaning member 41 acts as the exposure layer 412 to adsorb water molecules and other hydrophilic compounds due to its ability to form hydroxyl groups. This characteristic makes the entire structure highly effective at attracting and capturing polar molecules from the gaseous residues through its hydroxyl groups, thereby reducing the potential for contamination and improving the overall cleanliness of the semiconductor processing environment.

Example B3: The cleaning member 41, as depicted by FIG. 2, having a two-layer structure is provided. The cleaning member 41 includes a base layer 411 of silicon dioxide (SiO₂) and an exposure layer 412 of porous silica (SiOx).

In this embodiment, the exposure layer 412 includes silica (SiOx) with an increased surface roughness, wherein microscopic or submicroscopic features are formed on the outermost surface. These increased surface roughness enhance the surface area of the exposure layer 412, providing more active sites for the adsorption of hydrophilic compounds. The increased surface roughness also aids in physically trapping water molecules, which are naturally attracted to the polar SiOx surface. The polar nature of the silica surface, combined with the physical trapping effect of the uneven surface, enables the effective capture of water and other polar compounds. As a result, the concentration of these hydrophilic residues in the semiconductor processing tool 10 is reduced, thereby reducing the potential for contamination and improving the overall cleanliness of the semiconductor processing environment.

Example B4: The cleaning member 41, as depicted by FIG. 2, having a two-layer structure is provided. The cleaning member 41 includes a base layer 411 of silicon dioxide (SiO₂) and an exposure layer 412 of hydrophilic polymer.

In this embodiment, the exposure layer 412 includes a hydrophilic polymer such as PVA, PEG, or cellulose, which has strong affinity for water due to their hydrophilic functional groups. PVA contains hydroxyl groups, PEG features ether linkages, and cellulose has a high density of hydroxyl groups, all of which can form hydrogen bonds with water molecules and other polar compounds. In operation, the exposure layer 412 of hydrophilic polymer attracts and adsorbs water molecules and other polar compounds from the gaseous residues through hydrogen bonding. This selective adsorption of hydrophilic compounds helps to reduce the presence of water and other polar contaminants in the semiconductor processing tool 10, thereby reducing the potential for contamination and improving the overall cleanliness of the semiconductor processing environment.

In addition to PVA, PEG, and cellulose, several other hydrophilic polymers could be used as the exposure layer 412 in this cleaning member. Alternative material includes Polyacrylic Acid (PAA), Polyvinylpyrrolidone (PVP), Polyethyleneimine (PEI), or Polyacrylamide (PAM). These polymer also functions as the active layer that interacts with the hydrophilic residues. By choosing the appropriate polymer, the structure can be optimized for a wide range of applications, enables effective management of hydrophilic residues in various semiconductor processing environments.

In accordance with some embodiments, the cleaning members 41 act as a catalyst to facilitate chemical reaction of the residue in the semiconductor processing tool 10. Example C1 to Example C4 of such configuration are provided below.

Example C1: The cleaning member 41, as depicted by FIG. 2, having a two-layer structure is provided. The cleaning member 41 includes a base layer 411 of magnesium oxide (MgO) and an exposure layer 412 consisting of ruthenium (Ru) nanoparticle.

The base layer 411 of MgO serves as the foundational support for the cleaning member. Magnesium oxide has high thermal stability and chemical inertness, which make it suitable for use in high-temperature environments. MgO also provides a suitable substrate for the formation, such as through dispersion, of the Ru nanoparticles, enables the exposure layer 412 to be maintained its catalytic activity. Ruthenium nanoparticles in the exposure layer 412 is a transition metal has catalytic properties, which facilitates hydrogenation and decomposition reactions. The nanoparticle form of Ru is chosen to maximize the surface area available for catalytic activity, thereby enhancing the interaction with residues, such as NH₄.

In operation, the cleaning member brings NH₄ residues into contact with the Ru nanoparticle in the exposure layer 412. When NH₄ molecules interact with the Ru nanoparticles, the exposure layer 412 facilitates the decomposition of NH₄ into nitrogen (N₂) and hydrogen (H₂) gases. Ruthenium acts as a catalyst by lowering the activation energy required for this reaction, allowing it to proceed more efficiently, thereby reducing the potential for contamination and improving the overall cleanliness of the semiconductor processing environment.

Example C2: The cleaning member 41′, as depicted by FIG. 3, having a three-layer structure is provided. The cleaning member 41′ includes a base layer 411 of nickel oxide (NiO), a middle layer 413 of nickel (Ni), and an exposure layer 412 of palladium (Pd).

The base layer 411 of nickel oxide (NiO) has a high affinity for oxygen, making it fit for oxygen-related reactions. In this embodiment, the base layer 411 of nickel oxide NiO not only provides structural support but also participates in the catalytic process to dissociate O₂ molecules into reactive oxygen species (O*). The Middle Layer 413 of nickel (Ni) serves as a conductive interlayer that enhances electron transfer between the base layer 411 of NiO and the exposure layer 412 of Pd. The exposure layer 412 of Pd is the active catalytic surface at which oxidation and hydrogenation reactions occur.

In operation, the cleaning member 41′ first adsorbs O₂ molecules onto the NiO base layer 411, facilitating the dissociation of O₂ into atomic oxygen (O*). In addition, exposure layer 412 of Pd may catalyze the dissociation of O₂ molecules into two O* atoms. These O* atoms may participate in further reactions on the exposure layer 412 of Pd. For example, in cases where water and electrons are present, the Pd surface catalyzes the formation of hydroxide ions (OH⁻) through the reaction 2O*+2H₂O+4e⁻→4OH⁻, thereby reducing the potential for contamination and improving the overall cleanliness of the semiconductor processing environment.

Example C3: The cleaning member 41, as depicted by FIG. 2, having a two-layer structure is provided. The cleaning member 41 includes a base layer 411 of silicon dioxide (SiO₂) and an exposure layer 412 consisting of ruthenium dioxide (RuO₂).

The base layer 411 of SiO₂ provides the mechanical support for the cleaning member. The exposure layer 412 of RuO₂ has catalytic properties and can be used in oxidation reactions. For example, RuO₂ is effective in facilitating the conversion of CO to CO₂ by providing active sites for the reaction to occur. The presence of RuO₂ lowers the activation energy required for the oxidation of CO, making the process more efficient.

In operation, the cleaning member 41 brings CO residues into contact with the exposure layer 412 of RuO₂. As CO molecules interact with the RuO₂ surface, the exposure layer 412 catalyzes the oxidation of CO by oxygen, converting it into CO₂. The CO oxidation reaction by the exposure layer 412 of RuO₂ reduces the concentration of toxic CO residues in the processing environment, leading to a cleaner and safer semiconductor manufacturing process.

Example C4: The cleaning member 41, as depicted by FIG. 2, having a two-layer structure is provided. The cleaning member 41 includes a base layer 411 of cerium dioxide (CeO₂) and an exposure layer 412 made of noble metals such as gold (Au), palladium (Pd) rhodium (Rh), silver (Ag), iridium (Ir), or Osmium (Os).

The base layer 411 of CeO₂ provides both structural support and additional catalytic activity. Cerium dioxide is a catalyst, for example, in redox reactions. The noble metals of the exposure layer 412 are chosen for their exceptional catalytic properties in facilitating organic reactions by breaking down aromatic compounds like chlorobenzene.

In operation, the cleaning member 41 may bring C₆H₅Cl residues into contact with the exposure layer 412 which consists of noble metal. The noble metal the reaction between C₆H₅Cl and water, leading to the formation of CO₂, HCl, and H₂. The overall reaction can be represented as C₆H₅CL+12H₂O→6CO₂+HCL+14H₂. The noble metals provide active sites where the reaction can occur more efficiently, lowering the activation energy required and increasing the reaction rate. The base layer 411 of CeO₂ also helps the catalytic activity of the noble metal exposure layer 412 by participating in the redox processes that occur during the reaction. The combination of CeO₂ and noble metals in this cleaning member 41 creates a highly effective system for decomposing complex organic residues like C₆H₅Cl, thereby reducing the potential for contamination and improving the overall cleanliness of the semiconductor processing environment.

In accordance with some embodiments, the cleaning members 41 not only act as catalysts to facilitate the chemical reactions of residues but also directly react with the residues within the semiconductor processing tool 10. Example D1 of such a configuration is provided below.

Example D1: The cleaning member 41, as depicted by FIG. 2, having a two-layer structure is provided. The cleaning member 41 includes a base layer 411 of titanium dioxide (TiO₂) and an exposure layer 412 composed of noble metals such as gold (Au), platinum (Pt), or palladium (Pd).

In this embodiment, the base layer 411 of TiO₂ not only serves as the structural foundation of the composite but also actively participates in the chemical reaction. The noble metals of the exposure layer 412 are chosen for their exceptional catalytic properties in facilitating hydrogenation and alloy formation reactions.

In case where hydrogen (H₂) is present, the cleaning members adsorbs H₂ molecules onto the exposure layer 412, where they are dissociated into atomic hydrogen by noble metal. The Pt component of the exposure layer 412 may be involved in this process, as it has a high affinity for hydrogen and can efficiently break the H—H bond.

These hydrogen atoms then migrate to the TiO₂ base layer 411, where they react with the titanium atoms in the lattice. The reaction progresses as two H₂ molecules interact with TiO₂ and the Pt atoms, resulting in the formation of a titanium-platinum alloy (TiPt₃) and water (H₂O). The overall reaction can be represented as TiO₂+2H₂+3Pt→TiPt₃+2H₂O. In this reaction, the TiO₂ base layer 411 is consumed, and a new material, TiPt₃, is formed on the surface. This alloy formation can be advantageous for various applications, including catalysis and material science.

The presence of Au and Pd in the exposure layer 412 can further enhance the reaction by modifying the electronic properties of the Pt atoms, thereby influencing the reaction kinetics and the stability of the resulting TiPt₃ alloy. The combination of TiO₂ and noble metals in this cleaning member enables the efficient formation of TiPt₃, with the added benefit of water production, which can be easily managed in the processing environment.

The structure and function of cleaning members 42, 43, and 44 can be the same as any of the embodiments of cleaning members 41 described above, and will not be repeated for simplicity.

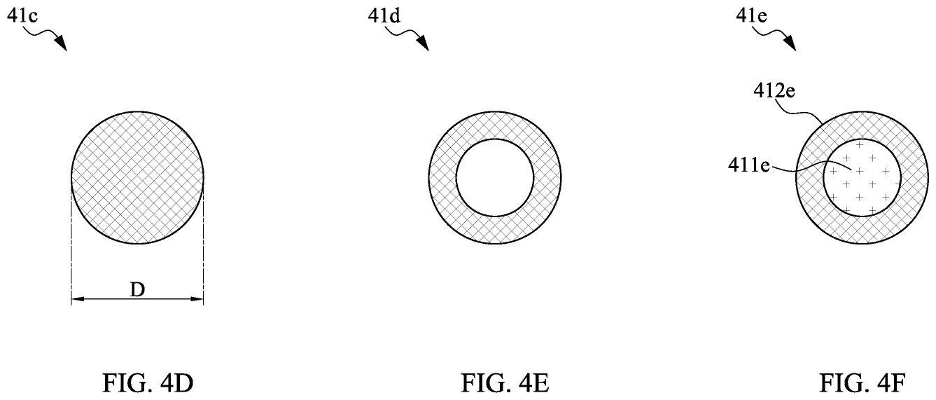

The cleaning members 41, 42, 43, and 44 can be configured in various geometric shapes to suit different applications and locations within the semiconductor processing tool. For example, the base layer of the cleaning members 41, 42, 43, and 44 may take the form of a plate (FIG. 4A), a cube (FIG. 4B), a cylinder (FIG. 4C), a sphere (FIG. 4D), or a hollow sphere or tubular shape (FIG. 4E). In the embodiment shown in FIG. 4A, the cleaning members 41, 42, 43, and 44 may have dimensions where the length (L) and width (W) are greater than the height (H), and the ratio of L/H is greater than 20. For instance, H may range from 0.1 cm to 0.5 cm, L from 5 cm to 15 cm, and W from 5 cm to 10 cm. In the cubic embodiment shown in FIG. 4B, the cleaning members 41, 42, 43, and 44 may have dimensions where 0.1 cm<L<5 cm. For the cylindrical shape depicted in FIG. 4C and the spherical shape in FIG. 4D, the cleaning members 41, 42, 43, and 44 may have diameters (D) ranging from 0.1 cm to 5 cm. However, these dimensions are not limiting, and the exact size and shape can be adapted based on the specific requirements of the application.

The cleaning members 41, 42, 43, and 44 can be configured in various geometric shapes to suit different applications and locations within the semiconductor processing tool. For example, the base layer of the cleaning members 41, 42, 43, and 44 may take the form of a plate (FIG. 4A), a cube (FIG. 4B), a cylinder (FIG. 4C), a sphere (FIG. 4D), or a hollow sphere or tubular shape (FIG. 4E). In the embodiment shown in FIG. 4A, the cleaning members 41, 42, 43, and 44 may have dimensions where the length (L) and width (W) are greater than the height (H), and the ratio of L/H is greater than 20. For instance, H may range from 0.1 cm to 0.5 cm, L from 5 cm to 15 cm, and W from 5 cm to 10 cm. In the cubic embodiment shown in FIG. 4B, the cleaning members 41, 42, 43, and 44 may have dimensions where 0.1 cm<L<5 cm. For the cylindrical shape depicted in FIG. 4C and the spherical shape in FIG. 4D, the cleaning members 41, 42, 43, and 44 may have diameters (D) ranging from 0.1 cm to 5 cm. However, these dimensions and shapes are not limiting, and the exact size and geometry of the cleaning members can be tailored to meet the specific requirements of different locations and functions within the semiconductor processing tool.

The exposure layer of the cleaning members 41, 42, 43, and 44 may be formed on the outermost surface of the base layer, which is in direct contact with the interior environment of the semiconductor processing tool 10 (FIG. 1), using suitable methods such as coating or deposition. Coating thickness should be sub-nanometer level (<500 nm) to maximize specific surface area. In some embodiments, both the base layer and the exposure layer are bulk materials with significant thickness, rather than thin films, and may be arranged in a stacked configuration. Alternatively, as shown in the embodiment of FIG. 4F, the base member may be surrounded by the exposure layer. For example, the base layer could be spherical, with the exposure layer forming a hollow sphere that completely encloses the base layer.

The versatility in the design of the cleaning members allows for their integration into a wide variety of environments within the processing tool, including tight spaces, irregular surfaces, and areas with complex geometries. For instance, the shape of the cleaning members can be adjusted to optimize contact with residues or to fit within components of the processing tool. Additionally, combinations of different shapes and sizes can be employed within the same tool to enhance overall cleaning efficiency, allowing for comprehensive residue removal. The selected shape may also be influenced by the type of residues being targeted, and the nature of the chemical reactions involved. Therefore, while specific embodiments are illustrated and described, the invention is not limited to these examples, and various modifications in shape, size, and configuration of the cleaning members are within the scope of the invention.

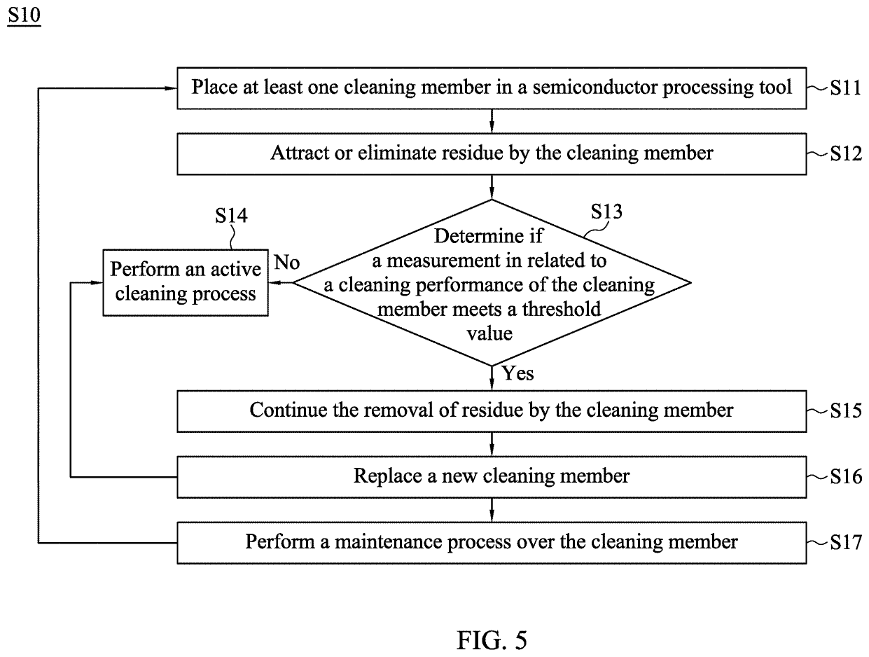

FIG. 5 is a flow chart illustrating a method S10 for controlling the semiconductor process environment, in accordance with various aspects of one or more embodiments of the present disclosure.

The method S10 includes operation S11 in which at least one of the cleaning members 41, 42, 43, and 44 is positioned within the semiconductor processing tool 10. For instance, with reference to FIG. 1, due to the high temperatures generated by the radiation source 162, particles or excited substances are likely to form within the chamber 16 during operation. Therefore, the cleaning member 41 is placed near the radiation source 162 to capture or neutralize these particles and excited substances, thereby reducing contamination within the chamber 16. Alternatively, the cleaning member 42 may be placed near the inlet 323 of the conduit 322 to eliminate gaseous elements from the chamber 16, effectively pre-treating toxic or explosive gases (such as hydrogen) before they exit the chamber. Additionally, the cleaning members 43 and 44 can be positioned adjacent to the first door 151 and the second door 152, respectively, to remove residual substances, such as moisture and oxygen, from the ambient environment that are not fully evacuated by the first pump 31 in the load lock module 15.

The method S10 also includes operation S12 in which contaminations or residues is attracted or eliminated by using the cleaning members 41, 42, 43 and 44. In accordance with some embodiments, the cleaning member 41 or the cleaning member 41′ is used to attract and absorb hydrophobic compounds from the residues in the semiconductor processing tool 10, as described in Examples A1-A4 mentioned above. In other embodiments, the cleaning members 41 are utilized to attract and absorb hydrophilic compounds from the residues, as outlined in Examples B1-B4. Additionally, the cleaning members 41 or the cleaning member 41′ may act as catalysts to facilitate the chemical reactions of residues within the semiconductor processing tool 10, as demonstrated in Examples C1-C4. Furthermore, in certain embodiments, the cleaning members 41 not only act as catalysts but also directly react with the residues, as discussed in Example D1. The materials used for the cleaning members can be selected based on the specific residues targeted for removal.

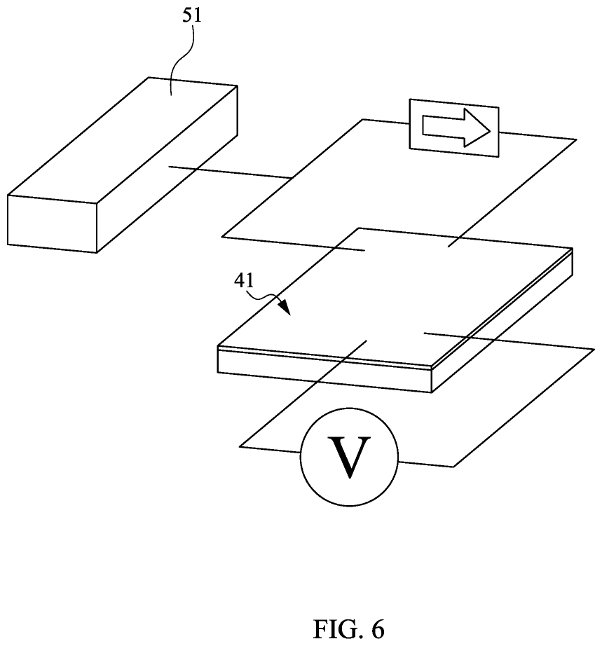

The method S10 also includes operation S13 in which a measurement related to the cleaning performance of the cleaning member is determined to meet a threshold value. In some embodiments, the cleaning member can be monitored in real-time to measure the electrical properties of the cleaning member. For example, as shown in FIG. 6, an electric meter 51 is electrically connected to the surface (e.g., the surface of the exposure layer) of the cleaning member 41. In cases where MgNi or Mg₂Ni serves as the exposure surface to absorb hydrogen over time, the electrical properties (such as resistance) of MgNi or Mg₂Ni will gradually increase. An increase in resistance indicates a decline in absorption efficiency. Therefore, by measuring whether the electrical properties meet the threshold value, it can be determined whether the cleaning efficiency of the cleaning member in absorbing specific substances remains within the desired range.

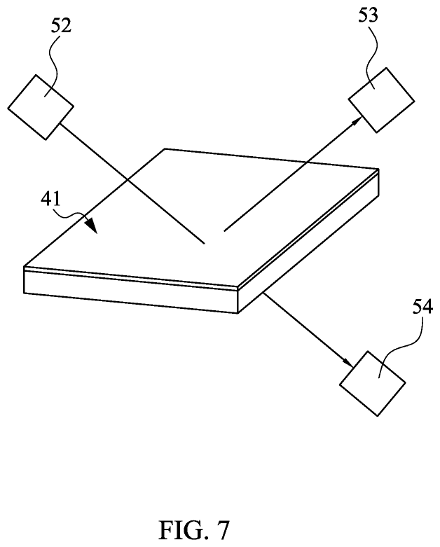

In other embodiments, the cleaning member can be monitored in real-time using Optical Critical Dimension (OCD) measurements to assess the optical properties of the cleaning member. For example, as shown in FIG. 7, a light source 52 projects light onto the surface (e.g., the surface of the exposure layer) of the cleaning member, while a reflectance detector 53 and a transmittance detector 54 are used to detect the light reflected from or passing through the cleaning member 41. In cases where carbon serves as the exposure surface to absorb hydrocarbons over time, the thickness of the carbon layer will increase, leading to a decrease in the refractive index (n value) and an increase in the extinction coefficient (k value). Changes in the n and k values from OCD measurements indicate the thickness and growth of the absorbent layer, with more rapid changes reflecting better passive cleaning performance. An increase in carbon thickness presents a decrease in absorption efficiency. Therefore, by measuring whether the optical properties meet the threshold value, it can be determined whether the cleaning member's efficiency in absorbing specific substances remains within the desired range.

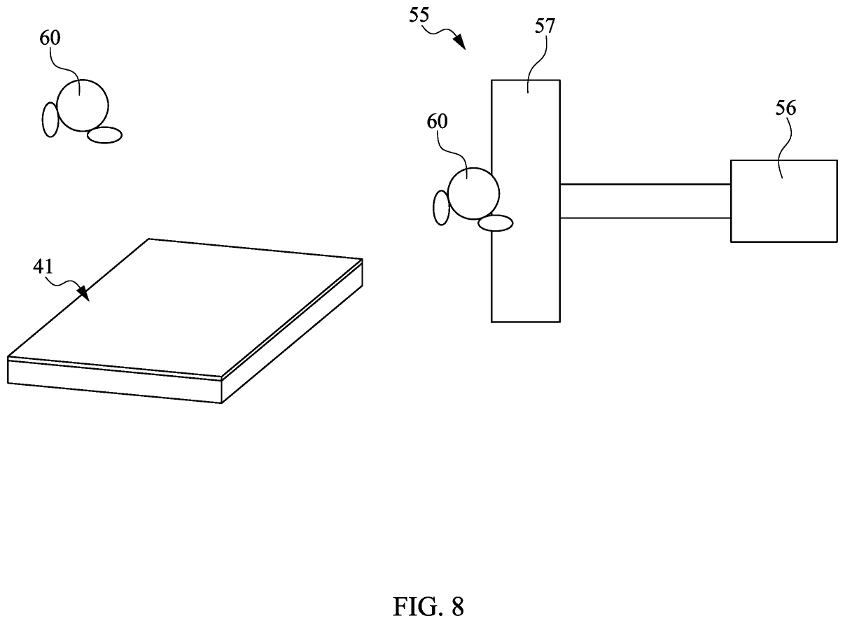

In other embodiments, at least one property of the residues in the processing chamber i measured. For example, a residual gas analyzer (RGA) 55 can be used to identify and monitor the composition of gases within the chamber. In one exemplary embodiment, as shown in FIG. 8, the RGA 55 can includes a detector 56 and a filament 57 electrically connected to the detector 56. The RGA 55 is used to detect the presence of specific residue gases, indicating whether the cleaning members are effectively removing contaminants by analyzing the types and amounts of gases present. If the RGA 55 identifies an increase in specific residue gases, this may suggest that the cleaning efficiency has declined.

If the results from operation S13 indicate that the threshold value is not met, initiate an active cleaning process (operation S14). For example, nitrogen gas may be purged into the processing chamber 16 to remove contaminants. Other gases or cleaning agents may also be introduced to effectively neutralize or dislodge the residues that the cleaning members can not handle adequately. This active cleaning step prevents adverse effects on the ongoing semiconductor processes from the chamber environment.

If the results from operation S13 shows that the threshold value is met, proceed to operation S15, where the cleaning members continue to remove contaminants or residues. During this phase, the system may continuously monitor the environment to determine if the cleaning members remain effective and that the processing conditions are maintained within the desired parameters.

The method S10 also includes operation S16 in which the cleaning member is replaced by with a new one. In some embodiments, during operation S15, the process of monitoring of electrical, optical, or residual gas data continues, and data is utilized to assess the appropriate timing for replacing the cleaning member during scheduled maintenance. This proactive replacement helps prevent any unexpected decline in cleaning efficiency, so as to keep the semiconductor processing environment remains uncontaminated and stable.

The method S10 also includes operation S17 in which a maintenance process on the cleaning member is performed. After the cleaning members are removed from the semiconductor processing tool, they may undergo a maintenance process, which could include washing, drying, or recoating new material onto the exposure layer over the base layer. In some embodiments, the cleaning members might be processed by replacing the exposure layer entirely, depending on the extent of wear or contamination. These procedure reduces costs and enhances environmental sustainability by minimizing waste. Additionally, the conditioned cleaning members can be reintroduced into the semiconductor processing tool.

The present disclosure provides embodiments of a method for passive self-cleaning in semiconductor tools, creating a very clean manufacturing environment at a low cost. The method utilizes cleaning members designed for the residues generated within the semiconductor processing tool, allowing for a highly targeted and efficient cleaning process. By strategically placing cleaning members with different compositions at various locations, the system can effectively manage a wide range of contaminants. Therefore, the product yields of semiconductor devices manufactured by the semiconductor processing tool are increased, and the overall efficiency and reliability of the manufacturing process are improved.

According to some embodiments of present disclosure, a cleaning member for use in a semiconductor processing tool is provided. The cleaning member includes a base layer; and an exposure layer formed on the base layer. The exposure layer is configured to interact with residues in an interior of the semiconductor processing tool or act as a catalyst to facilitate chemical reactions of the residues in the interior of the semiconductor processing tool.

According to some embodiments of present disclosure, a semiconductor processing tool is provided. The semiconductor processing tool includes a processing chamber in which a semiconductor wafer is processed; and a cleaning member removably disposed in the processing chamber. The cleaning member is configured to facilitate physical adsorption, catalysis, or chemical reactions with the residues in the processing chamber.

According to other embodiments of present disclosure, a method is provided. The method includes placing a cleaning member in a processing chamber of a semiconductor processing tool. The method also includes creating a vacuum in the processing chamber. Furthermore, the method includes eliminating at least one compound from the residues in the processing chamber by the cleaning member. The cleaning member is configured to facilitate physical adsorption, catalysis, or chemical reactions with the residues in the processing chamber.

The foregoing outlines structures of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A cleaning member for use in a semiconductor processing tool, comprising:
a base layer;
an exposure layer; and
a middle layer disposed between the base layer and the exposure layer,
wherein the exposure layer is configured to interact with residues in an interior of the semiconductor processing tool by attracting hydrophobic compounds from the residues, and wherein the middle layer is configured to act as a catalyst for an interaction between the exposure layer and the residues.

2. The cleaning member of claim 1, wherein the base layer comprises silicon dioxide (SiO₂).

3. The cleaning member of claim 1, wherein the middle layer comprises ruthenium dioxide (RuO₂).

4. The cleaning member of claim 1, wherein the middle layer comprises a noble metal selected from the group consisting of platinum (Pt), palladium (Pd), and gold (Au).

5. The cleaning member of claim 1, wherein the exposure layer comprises carbon.

6. The cleaning member of claim 1, wherein the exposure layer comprises a fluoride material.

7. The cleaning member of claim 6, wherein the fluoride material is selected from the group consisting of magnesium fluoride (MgF₂) and calcium fluoride (CaF₂).

8. The cleaning member of claim 1, wherein the base layer is in a geometric shape selected from a plate, a cube, a cylinder, a sphere, a hollow sphere, or a tubular shape.

9. The cleaning member of claim 1, wherein the exposure layer comprises a thin film formed on at least an outer surface of the middle layer, and wherein the thin film has a thickness of less than 500 nm to maximize a specific surface area.

10. A cleaning member for maintaining an ultra-clean environment within a semiconductor processing tool, comprising:
a base layer;
an exposure layer; and
a middle layer interposed between the base layer and the exposure layer,
wherein the exposure layer is configured to interact with residues in an interior of the semiconductor processing tool by attracting hydrophobic compounds from the residues, and wherein the middle layer is configured to catalyze reactions to alter a chemical structure of the hydrophobic compounds to facilitate adsorption by the exposure layer.

11. The cleaning member of claim 10, wherein the middle layer is configured to catalyze oxidation-reduction reactions to break down complex organic molecules in the residues.

12. The cleaning member of claim 10, wherein the exposure layer comprises carbon configured to physically adsorb the hydrophobic compounds through van der Waals forces.

13. The cleaning member of claim 10, wherein the exposure layer comprises a fluoride material configured to attract and adsorb the hydrophobic compounds through non-polar interactions.

14. The cleaning member of claim 10, wherein the base layer comprises silicon dioxide (SiO₂).

15. The cleaning member of claim 10, wherein the middle layer comprises ruthenium dioxide (RuO₂).

16. The cleaning member of claim 10, wherein the middle layer comprises a noble metal selected from the group consisting of platinum (Pt), palladium (Pd), and gold (Au).

17. A cleaning member for use in a semiconductor processing tool, wherein the cleaning member is configured to be positioned adjacent to at least one of a radiation source, an inlet of an exhaust conduit, or a load lock door within the semiconductor processing tool to remove residual substances, the cleaning member comprising:
a base layer;
an exposure layer; and
a middle layer interposed between the base layer and the exposure layer,
wherein the middle layer comprises a catalyst material, and wherein the exposure layer comprises a hydrophobic surface configured to attract and physically adsorb non-polar compounds from gaseous residues in an interior of the semiconductor processing tool.

18. The cleaning member of claim 17, wherein the base layer comprises silicon dioxide (SiO₂), the middle layer comprises ruthenium dioxide (RuO₂), and the exposure layer comprises carbon or a fluoride material.

19. The cleaning member of claim 17, wherein the base layer is in a geometric shape selected from a plate, a cube, a cylinder, a sphere, a hollow sphere, or a tubular shape, and the exposure layer has a thickness of less than 500 nm.

20. The cleaning member of claim 17, wherein the exposure layer comprises carbon possessing a high surface area and a strong affinity for non-polar molecules to selectively adsorb the non-polar compounds.
